(19) United States
(12) Patent Application Publication
(10) Pub. No.: US 2015/0318527 A1
(43) Pub. Date: Nov. 5, 2015

(54) PLASMA TREATMENT OF AN ELECTROCHEMICAL MEMBRANE

(71) Applicant: Ford Global Technologies, LLC, Dearborn, MI (US)

(72) Inventors: Kevin James Rhodes, Dearborn, MI (US); Larry Paul Haack, Ann Arbor, MI (US)

(73) Assignee: Ford Global Technologies, LLC, Dearborn, MI (US)

(21) Appl. No.: 14/269,531

(22) Filed: May 5, 2014

(51) Int. Cl. H01M 2/14; H01M 10/0525; H01M 2/16

(52) U.S. Cl. CPC H01M 2/145; H01M 2/1653; H01M 10/0525

(57) ABSTRACT

A method for treating an electrochemical membrane includes providing a porous film having a first outer surface and a second opposed outer surface, and treating at least a portion of the first outer surface with an air plasma jet at atmospheric pressure to functionalize the at least a portion of the first outer surface with a plurality of oxygen functional groups. A battery separator has an ionically conductive separator film having a first functionalized outer surface with a plurality of oxygen atoms providing one to twenty percent of the total atoms present on the surface to provide a greater electrolytic uptake than a non-functionalized film. An electrochemical membrane has an ionically conductive microporous film with at least a portion of the first side having a plurality of polar functional groups introduced by air plasma treatment at atmospheric pressure.

### TECHNICAL FIELD

Various embodiments relate to a porous membrane for use in an electrochemical application such as a separator for a battery.

### BACKGROUND

A nonreactive porous membrane may be used in devices such as batteries and fuel cells to provide electrical isolation between anode and cathode while permitting ionic conduction. For example, in a lithium ion battery, the separator is commonly an open cell porous polyolefin membrane positioned between the electrodes. Ionic conduction through the membrane is facilitated by saturating the film with a polar electrolyte. An ideal separator would be chemically inert in the battery environment, have a controlled and interconnected pore structure, and demonstrate rapid and extensive wetting by the intended electrolyte. At present, commercial separators are produced in several fashions including axial stretching, phase inversion, or spinning of fibers to form a non-woven membrane. The polymers used normally include polyolefins such as polypropylene and polyethylene but may also be prepared from other materials such as cellulose and its derivatives. Due to the hydrophobicity of the olefinic material used in the sheets, the present separators may be poorly wet by the polar electrolytes, which leads to a need for excess electrolyte material in the battery or other electrochemical cell and can significantly prolong device fabrication times due to the need for separator soaking in electrolyte.

### SUMMARY

In an embodiment, a method for treating an electrochemical membrane is provided. A porous film is provided and has a first outer surface and a second opposed outer surface. At least a portion of the first outer surface is treated with an air plasma jet at atmospheric pressure to functionalize the at least a portion of the first outer surface with a plurality of oxygen functional groups.

In another embodiment, a battery separator is provided with an ionically conductive separator film having a first functionalized outer surface with a plurality of oxygen atoms providing one to twenty percent of the total atoms present on the surface to provide a greater electrolytic uptake than a non-functionalized film.

In yet another embodiment, an electrochemical membrane is provided with an ionically conductive microporous film having a first side and a second opposed side. At least a portion of the first side has a plurality of polar oxygen functional groups introduced by air plasma treatment at atmospheric pressure.

Various embodiments of the present disclosure have associated, non-limiting advantages. For example, an atmospheric pressure air plasma jet is used to treat an outer surface of a porous membrane to modify the surface properties of the membrane, while operating at a sufficiently low temperature such that the membrane pore structure remains intact. The atmospheric pressure air plasma treatment may functionalize the membrane surface and lead to increased solvent uptake and a reduced amount of solvent needed for use in the electrochemical cell.

### BRIEF DESCRIPTION OF THE DRAWINGS

FIG. 1 illustrates a schematic of an atmospheric pressure air plasma (APAP) process for a porous membrane according to an embodiment;

FIG. 2 illustrates a graph comparing contact angles for untreated and APAP treated porous separator membranes;

FIG. 3 illustrates a graph comparing electrolyte uptake for untreated and APAP treated porous separator membranes;

FIG. 4 is a photograph illustrating electrolyte retention for untreated and APAP treated porous separator membranes;

FIG. 5A and 5B illustrate FTIR spectra for the untreated and APAP treated porous separator membranes respectively; and

FIG. 6 illustrates EIS for the untreated and APAP treated porous separator membranes.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention. Description of constituents in chemical terms refers to the constituents at the time of addition to any combination specified in the description, and does not necessarily preclude chemical interactions among constituents of the mixture once mixed.

Electrochemical separators, which may be made from a polyolefin material including polyethylene and/or polypropylene, and the like, may be used in applications such as batteries, fuel cells, ultracapacitors, and other energy storage devices as a separator film providing for both ionic conduction and electrical insulation across the film. The film may be made from a sheet of the polyolefin material which has been stretched or otherwise processed to provide interconnected pores within the sheet, or to form a porous film with opposed outer surfaces. The membrane may be composed of a single layer or multiple layers of the same or different material laminated together. In one example, the pores may have a nominal size of approximately 50 nm (nanometers) for a lithium ion application such as a battery separator. In other embodiments, other pore sizes that are appropriate for the application may be provided, including pore sizes larger than or smaller than 50 nm. In one embodiment, the pore sizes are between 10 nm and 100 nm. The porous film is also known as microporous.

For a lithium ion battery application, the separator film may be used with an organic solvent and a salt. The solvent may contain carbonyl moieties in a nonaqueous solvent to dissolve the salt. The solvent may include, but is not limited to, ethylene carbonate (EC), diethyl carbonate (DEC), and others as are known in the art. The salt may be lithium hexafluorophosphate (LiPF₆), or another as are known in the art. In other examples, the separator film may be used with a battery having aqueous electrolytes, ionic liquids, and the like. As the membrane does not have inherent polarity, the membrane needs to be wet by the solvent and retain solvent.

By treating the membrane as described herein, the amount of the solvent, and associated weight of the solvent in an electrochemical application may be reduced, thereby providing safer, lighter, and cheaper batteries, fuel cells, etc. This is possible because the electrolyte wicks into and remains in the treated separator so that excess reservoirs of electrolyte as seen in a flooded cell are not necessary. Using less electrolyte reduces the amount of volatile organics in the battery, and also improves overall cell specific capacity by reducing weight. By using a plasma treated separator, the use of excess electrolyte in prismatic cells may be reduced or eliminated as an APAP treated separator holds the electrolyte effectively in its pores where it is needed to allow for ionic conduction across the membrane.

An atmospheric pressure air plasma (APAP) process is used in order to improve the rate and extent of electrolytic uptake and modify the surface properties of the membrane. The air plasma treatment modifies the surface properties of the membrane, and operates at a low temperature such that the membrane pore structure remains intact after treatment. APAP alters the surface of the plastic component in preparation for a coating but does not require the use of a low pressure chamber. The altered surface of the membrane results from the formation of a functionalized polymer layer during the plasma treatment. More specifically, many plastics have surface chemistries comprised of long non-polar polymer chains, which may have low surface energy. Moreover, these surfaces may also be chemically non-reactive. For example, TPO, polyethylene, and polypropylene are common examples of non-polar plastics. The application of APAP for use in treating a plastic or polymer surface prior to a coating such as paint being applied is described in U.S. Pat. No. 7,981,219, issued on Jul. 19, 2011 and incorporated by reference in its entirety herein.

Plasma treatment and modification of separator surfaces was previously examined with low pressure plasmas such as RF plasma, see for example, J. Y. Kim, Y. Lee, D. Y. Lim, Electrochimica Acta 54 (2009) 3714-3719. RF plasma is a batch process which must be conducted in a low-pressure environment requiring a vacuum pumping system, and also first required the saturation of the separator with acrylonitrile. By using an air plasma at ambient conditions, i.e. atmospheric pressure, the process may be done continuously and may also be easily added as a rapid in-line process within a separator production line.

An atmospheric-pressure air plasma nozzle positioned approximately 2 to 20 millimeters (mm) from a portion of one of the first and second sides or exterior surface of the membrane. The membrane or film is provided in a dry, untreated state, and the process occurs at ambient conditions. The nozzle moves relative to an outer surface of the membrane along a path at a speed in the range of approximately 50 to 600 mm/s. In another example, the membrane may be positioned on a moving platform such as a conveyor belt and pass under a row or a series of plasma jets. The nozzle may have various diameters. The nozzle directs a plasma jet onto at least a portion of the outer surface to produce a functionalized polymer layer covering the portion of the exterior surface. The first side of the membrane is treated, and then, in some embodiments, the membrane may be turned over and at least a portion of the second side or second outer surface may be treated. Additionally, in some examples, at least a portion of the pores within the membrane may also have a functionalized surface due to the plasma treatment, and also provide capillary action to aid in the electrolyte uptake.

The APAP treatment process occurs in the open atmosphere, and does not require a low pressure vacuum chamber. As such, APAP provides benefits over other conventional plasma treatments include vacuum plasma treatment, which requires batch treatment of the component and a low pressure chamber, which may be limiting for high production volume applications.

Functionalizing the surface polymers increases the surface energy and allows a coating to wet-out the surface and provide better electrolyte uptake. One functionalizing mechanism which may occur on a plastic surface from APAP treatment is oxidation and/or the addition of functional groups onto the surface polymers. Chemical conversion of the surface polymers by APAP treatment results in enhanced polar characteristics. An untreated membrane is typically a nonpolar material, and as such, has a hydrophobicity that leads to poor wettability by a polar electrolyte. By functionalizing the surface of the membrane with polar group by APAP, the polar membrane surface interfaces with a polar electrolyte, the surface tension between the two phases is minimized, allowing the liquid phase to spread more evenly onto the solid surface and wet-out the membrane.

The APAP process provides functional groups on the outer surface of the membrane or film, and these functional groups may include oxygen functional groups. The surface may be functionalized with reactive moieties consisting of polar groups including, but not limited to, hydroxyl and/or carbonyl.

The following experiments demonstrate at least one embodiment of the present invention.

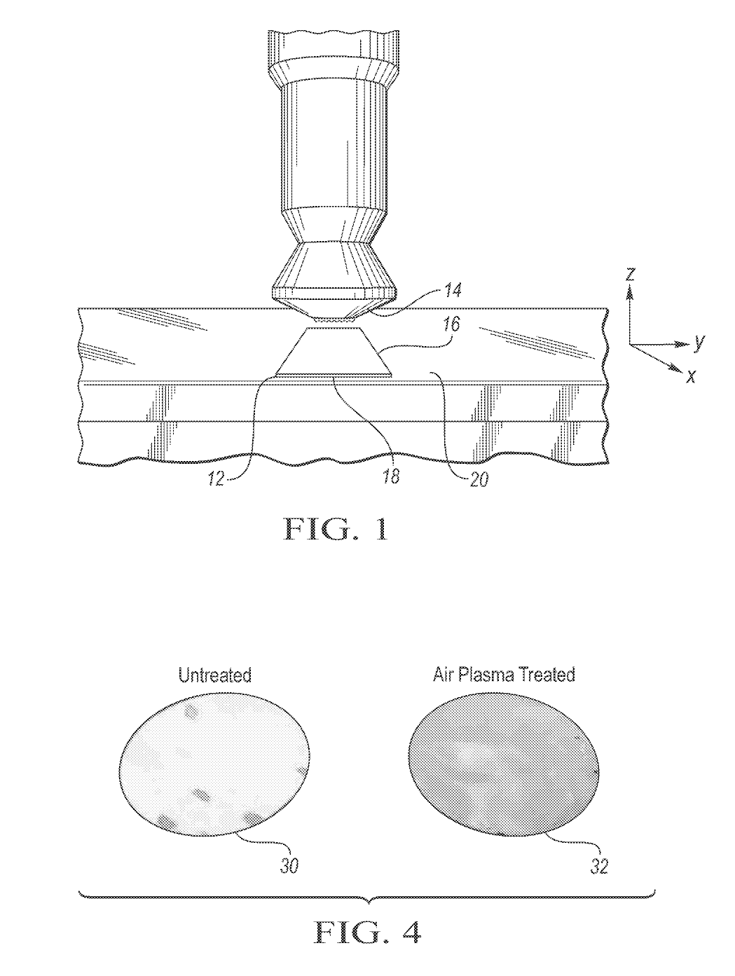

An atmospheric pressure air plasma (APAP) system is shown in FIG. 1. One or more sheets 12 of a porous film are passed under the rotating plasma jet 14 and rastered until one side of the sheet 12 was treated. A sheet 12 has a first side 16 and a second opposed side 18. The APAP treatment may be repeated on the back side of the separator sheet as well. One or both sides 16, 18 may be treated with APAP. APAP is used to treat at least a portion of one of the sides, and may be used to treat the entire side.

The porous film may be a separator film for use with a polar electrolyte, and may include a porous polyolefin film in an untreated, dry state, or a polypropylene film in an untreated, dry state. The porous microstructure may be provided by mechanically stretching the film, or otherwise as is known in the art. The porous film may be a monolayer microporous film made of polypropylene, i.e. CELGARD 2400, polyethylene, or another polyolefin or suitable material. In other examples, the film is a multilayer microporous film such as CELGARD 2320 or CELGARD 2325. The porous film may have a plurality of pores extending generally transversely to the outer surfaces of the film, and with a mean pore diameter of ten to one hundred nanometers. The pore mean diameter is generally unaffected by the APAP treatment.

The rotating plasma jet is an air plasma jet using air provided from a compressed air source.

In one example, CELGARD 2400 membranes are treated with OPENAIR plasma using a tabletop FLUME Plasma Pre-Industrial Evaluation System, manufactured by Plasmatreat North America, Inc., utilizing an RD1004 jet with a 2-inch diameter head rotated at 2000 revolutions per minute. In other examples, the size and rotational speed of the jet may be varied. The plasma is generated from a source of filtered compressed air at a current of 11 Amperes and a voltage of 14 kV. In other examples, the plasma may be generated from a higher or lower current, and/or a high or lower voltage. As shown in FIG. 1, the membrane is fixed to a platform 20 that can traverse under the plasma head 14, where dosage of the membrane is controlled by regulating the treatment speed and distance. In one embodiment, platform 20 may have at least two degrees of freedom to provide a raster pattern in the x- and y-directions. In other examples, the platform 20 may also move in a third direction, or z-direction. In this example, the treatment distance, or z-distance, was maintained at 10 mm, while the table 20 was traversed at a speed of 17 mm/second in the x-direction across the membrane 12. The table 20 was traversed under the 2-inch rotating head 14 in a raster pattern by moving the platform in the y-direction at the end of each pass across the membrane 12 in the x-direction. In the present example, the raster pattern provided an overlap of one inch in the y-direction, or half the diameter of the jet 14, between passes in order to maximize treatment homogeneity. In other examples, the treatment “z” distance may vary, as well as the speed across the sample, and the overlap for the raster pattern.

CELGARD 2400 is only one type of porous polypropylene separator material. Although the present example is described with respect to CELGARD 2400, other polymeric separator material may also be treated as described with respect to the present example with the APAP process. The treatment z-distance may be closer or further away and/or the rate at which the platform 20 is traversed in the x-direction may be faster or slower in order to provide similar results with various materials. The z-distance, speed of the platform in the x-direction, and the offset for the raster pattern may be optimized for the specific material and process conditions as is known in the art.

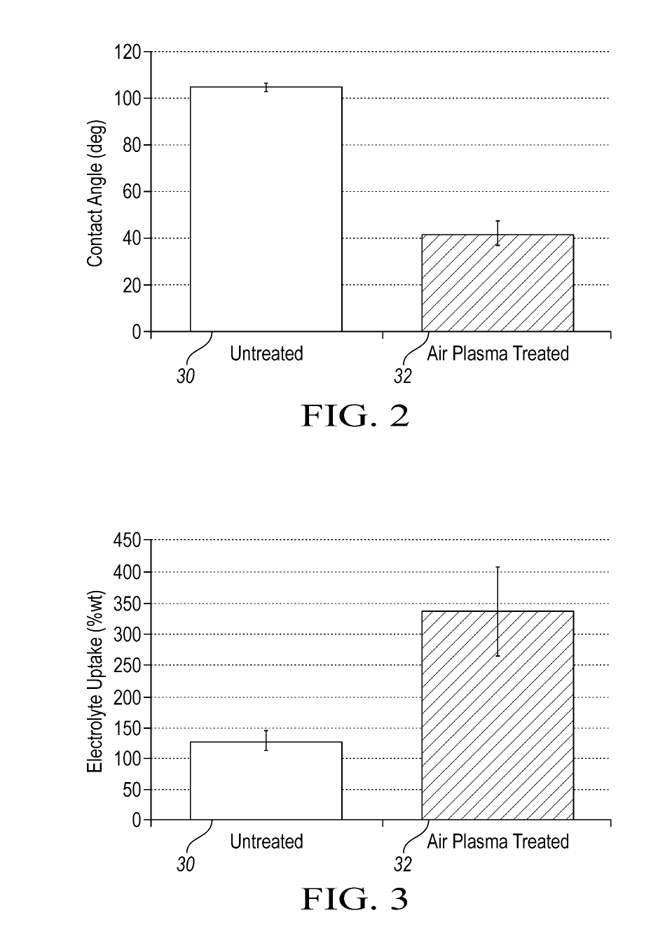

FIG. 2 illustrates the water contact angle as measured for an untreated CELGARD 2400 sample 30 and an APAP treated CELGARD 2400 sample 32. Treatment of the membrane 12 lowered the surface water contact angle from 105 to 42 degrees as shown in FIG. 2 with 95% confidence intervals. Therefore, the treated sample 32 has improved wettability and interaction with polar liquids. The treated surface of the membrane may have a contact angle of less than ninety degrees, and in a further embodiment, has a contact angle of less than forty-five degrees.

FIG. 3 illustrates the electrolyte uptake as a percent of sample weight for the untreated sample 30 and the APAP treated sample 32. Duplicate sets of three 12 mm diameter disks of both treated and untreated separator samples 32, 30 were weighed when dry, submerged in electrolyte for 30 minutes, removed and dabbed clean of any excess electrolyte on their surface, and then weighed again. The results are shown in FIG. 3 along with the 95% confidence interval for each. Air plasma treated samples 32 exhibited a greater than 250% weight increase due to electrolyte uptake compared to only 125% weight increase from electrolyte uptake for the untreated sample 30. In some examples, the APAP treated sample has a solvent uptake of at least two hundred percent by weight of the membrane.

FIG. 4 shows photographs of an untreated sample 30 and an APAP treated sample 32 thirty minutes after being removed from the electrolyte to illustrate the improved retention of the electrolyte by the treated sample 32. The plasma treated sample 32 is still wet with electrolyte thirty minutes after removal. The untreated sample 30 became opaque as soon as it was removed from the electrolyte indicating very poor wetting and electrolyte affinity compared to the treated sample 32.

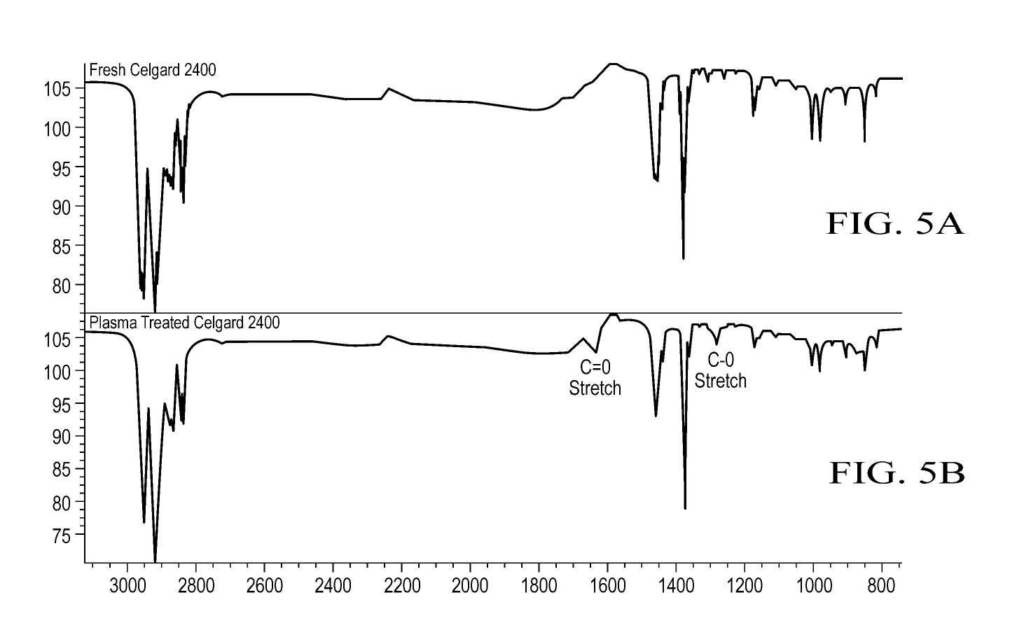

FIG. 5A illustrates Fourier transform infrared spectroscopy (FTIR) spectra taken in transmission mode for the CELGARD 2400 untreated sample 30. FIG. 5B illustrates FTIR spectra taken in transmission mode for the CELGARD 2400 APAP treated sample 32. The characteristic peaks of polypropylene are shown in FIGS. 5A and 5B. In FIG. 5A, the untreated sample only exhibits the polypropylene absorption bands. In FIG. 5B, for the APAP treated sample 32, additional absorption bands are seen at 1635 cm⁻¹ and 1270 cm⁻¹ and these correlate to C═O and C—O stretch vibration modes respectively, indicating the addition of oxygen functional groups to the surface of the polymeric materials. The increased surface polarity as shown in FIG. 5B provides the improved interaction and increase in uptake rate for the separator membrane with the polar liquid electrolyte.

TABLE 1
XPS of untreated and treated samples:

| | XPS Composition: Atomic % | | |
|---|---|---|---|
| | C | O | N |
| Untreated sample | 100.0 | — | — |
| APAP treated sample | 89.4 | 9.6 | 1.0 |

Table 1 above illustrates the surface elemental composition determined using X-ray photoelectron spectroscopy (XPS) of the untreated CELGARD 2400 sample and the APAP treated CELGARD 2400 sample. XPS provides a surface analysis of the elemental composition of a sample as the technique has a shallow penetration depth of approximately one micrometer; therefore the compositions shown in Table 1 are representative primarily of the material surface. The untreated sample showed only carbon (C) in its spectra which is to be expected for pure polypropylene as hydrogen (H) is not detected with XPS. Following APAP treatment, a significant amount of oxygen (O) was detected as well several oxidation states for carbon (C). A small amount of nitrogen (N) was also observed for the treated sample which was determined to be present as a nitrate. The XPS results agrees well with the FTIR results and demonstrates that the APAP treated separator is surface functionalized with highly polar groups, including hydroxyl and carbonyl, which cause an increase in surface energy. This provides the reduced contact angle of the treated material and the increased integration with polar electrolytes, as shown earlier in FIG. 2.

One or both surfaces of the membrane may be functionalized such that oxygen atoms provide 1 to 20 percent of the total atoms present on the surface, and in a further example, provide 5 to 15 percent of the total atoms present on the surface. One or both surfaces of the membrane may be functionalized such that nitrogen atoms provide 0.1 to 5 percent of the total atoms present on the surface.

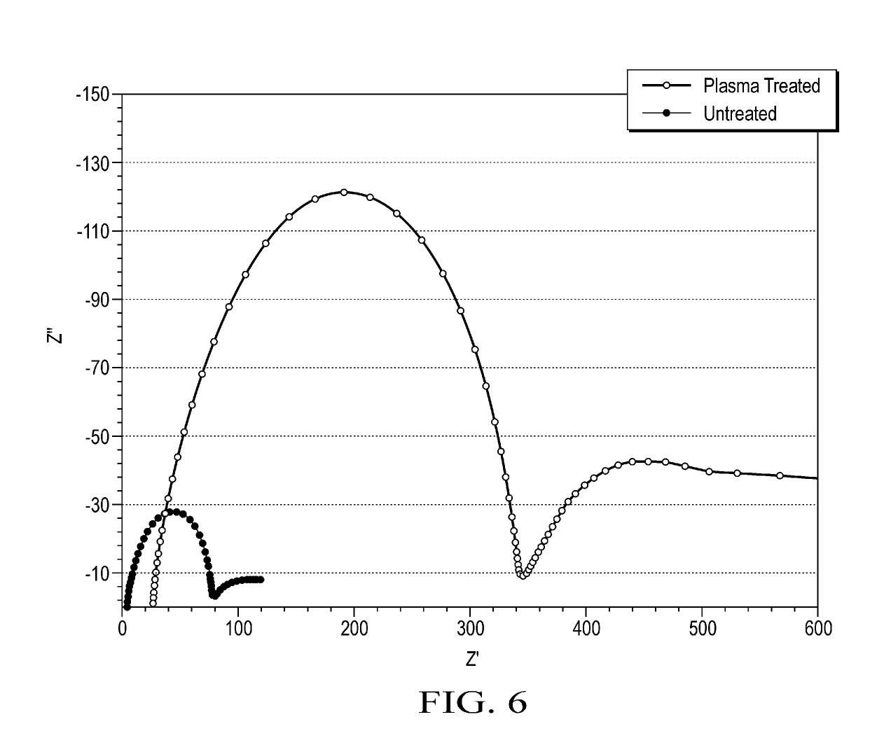

FIG. 6 illustrates results of electrochemical impedance spectroscopy (EIS) conducted for both the untreated CELGARD 2400 sample and the APAP treated CELGARD 2400 sample. Both separator samples were soaked in an electrolyte bath for twenty-four hours in an argon filled glove box. Two battery cells were prepared, one for each separator sample. Each separator was removed from the electrolyte bath immediately prior to inserting it into its cell for testing, and the outer surfaces of the separator sample were dabbed free of any excess electrolyte with a laboratory wipe. Each battery cell was assembled with two lithium foils, one on each side of the separator. The battery cell has an anode and a cathode. No extra electrolyte was added to the cells. EIS was performed after cell assembly using a 25 milli-Volt sweep from 1.0 MHz to 0.01 Hz. Based on the EIS results, the electrolyte diffusion resistance was 4.7 Ohms for the APAP treated sample and 29.5 Ohms for the untreated sample. The lower resistance of the APAP treated sample is due to the electrolyte that was absorbed and retained by the APAP treated separator and held in the space between the lithium foils where it may participate in lithium transfer across the separator. The APAP treated separator has a reduction in resistance of 84% compared to the untreated sample.

Experiments cycling of lithium half cells with lithium nickel manganese cobalt oxide (NMC) cathodes were performed for the APAP treated samples and no measurable loss of performance has been detected.

In further examples, attached —OH groups on the surface of the functionalized film may be used to tether other compounds. Any group that reacts with the exchangeable hydrogen of the —OH group may be therefore attached to the separator. In one non-limiting example, a crown ether used to sequester Mg ions that have dissolved from the cathode into the electrolyte may be attached using the —OH group.

Various embodiments of the present disclosure have associated, non-limiting advantages. For example, an atmospheric pressure air plasma jet is used to treat an outer surface of an electrochemical membrane to modify the surface properties of the membrane, while operating at a sufficiently low temperature such that the membrane pore structure remains after treatment. The atmospheric pressure air plasma treatment may functionalize the membrane surface and lead to increased solvent uptake and a reduced amount of solvent needed for use in the electrochemic cell.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method for treating a polymeric membrane for an electrochemical application, the method comprising:
providing a porous film having a first outer surface and a second opposed outer surface; and
treating at least a portion of the first outer surface with an air plasma jet at atmospheric pressure to functionalize the at least a portion of the first outer surface with a plurality of oxygen functional groups.

2. The method of claim 1 further comprising providing the air plasma jet operated at a current of at least ten amperes and at least twelve volts, and positioning a head for the air plasma jet at a distance of approximately one centimeter from the first outer surface.

3. The method of claim 1 wherein providing the porous film having the first outer surface and the second opposed outer surface comprises providing a porous polyolefin film in an untreated, dry state.

4. The method of claim 1 further comprising plasma treating at least a portion of the second outer surface with the air plasma jet at atmospheric pressure to functionalize the at least a portion of the second outer surface with another plurality of oxygen functional groups.

5. The method of claim 1 wherein plasma treating the at least a portion of the first outer surface with the air plasma jet at atmospheric pressure comprises raster scanning the air plasma jet across the first outer surface.

6. The method of claim 1 wherein plasma treating the at least a portion of the first outer surface with the air plasma jet at atmospheric pressure comprises moving the film beneath a series of adjacent plasma jets.

7. The method of claim 1 wherein providing the porous film having the first surface and the second opposed surface comprises forming a plurality of pores in the film having a mean diameter of 10-100 nanometers.

8. A battery separator comprising:
a porous separator film having a first functionalized outer surface with a plurality of oxygen atoms introduced by atmospheric pressure air plasma and providing one to twenty percent of total atoms present on the surface to provide a greater electrolytic uptake than a non-functionalized film;
wherein the functionalized surface comprises one or more reactive moieties selected from a polar group including hydroxyl, carbonyl, and a combination thereof.

9. The battery separator of claim 8 wherein the film has a second functionalized surface opposed from the first surface, the second functionalized surface with a plurality of oxygen atoms providing one to twenty percent of total atoms present on the surface.

10. The battery separator of claim 8 wherein the plurality of oxygen atoms provide five to fifteen percent of total atoms on the surface.

11. The battery separator of claim 8 wherein the film is comprised of a polyolefin.

12. The battery separator of claim 11 wherein the film is comprised of a polypropylene.

13. The battery separator of claim 8 wherein the first functionalized surface includes a plurality of nitrogen atoms providing 0.1 to five percent of total atoms present on the surface.

14. The battery separator of claim 8 wherein the separator film comprises a plurality of pores having a mean diameter of 10 to 100 nanometers.

15. The battery separator of claim 8 wherein the first functionalized surface provides a contact angle of less than ninety degrees.

16. The battery separator of claim 15 wherein the first functionalized surface provides a contact angle of less than 45 degrees.

17. The battery separator of claim 8 wherein at least a portion of a pore surface is functionalized with a plurality of oxygen atoms.

18. A lithium ion battery comprising a battery cell having a cathode and an anode with the battery separator of claim 8 interposed therebetween, the battery separator wetted by a polar electrolyte solvent.

19. The lithium ion battery of claim 18 wherein the battery separator has a solvent uptake of at least 200 percent by weight of the separator.

20. An electrochemical membrane comprising:
a microporous film having a first side and a second opposed side, at least a portion of the first side having a plurality of oxygen functional groups introduced by air plasma treatment at atmospheric pressure.
